(19) United States
(12) Patent Application Publication
(10) Pub. No.: US 2003/0026434 A1
(43) Pub. Date: Feb. 6, 2003

(54) Image pickup device

(75) Inventors: Hirokazu Naruto, Higashiosaka-Shi (JP); Kenji Nakamura, Takatsuki-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/211,850

(22) Filed: Aug. 2, 2002

(30) Foreign Application Priority Data
Aug. 6, 2001 (JP) P2001-238162

(51) Int. Cl. H04L 9/00

(52) U.S. Cl. 380/280; 713/193

(57) ABSTRACT

It is an object of the present invention to provide a digital camera at low costs, which has no limitation in picking up images and can be set a charge thereof reasonably.

In the case when a memory card with key information, which has a portion in which specific key information that may be referred to as image-pickup right is stored, is used, an image-pickup mode is made usable. Moreover, upon picking up an image, encrypted image data is generated by using an encrypting process that is different depending on picked-up images, and the resulting image data is stored in the memory card with key information together with thumbnail images that are not encrypted and tag information consisting of camera manufacturing information and image-pickup conditions. Then, the memory card with key information is brought to a data processing station or a terminal connected to a network, so that a decrypting process based upon the tag information is carried out on the encrypted image data by paying the corresponding charge, and the picked-up image data can be reproduced.

This application is based on application No. 2001-238162 filed in Japan, the contents of which are hereby incorporated by reference.

### BACKGROUND OF THE INVENTION

1. Field of the Invention

The present invention relates to a digital camera.

2. Description of the Background Art

Because of rapid widespread use of digital cameras, there has been a tendency of reduction in a cost per product. However, at present, the digital camera has more number of electric parts such as image-pickup elements and image display unit, and is more expensive than a camera using silver halide films.

For this reason, Japanese Patent Application Laid-Open No. 2000-196931 has disclosed a system capable of providing a digital camera at low prices by recycling the its main body.

However, since the above-mentioned system disclosed in the gazette is formed on the assumption that the entire camera bodies are recycled, the picked-up image data is stored in an internal memory medium. For this reason, in order to decrypt the picked-up image data, the camera main body needs to be brought to a shop, and this makes the system inconvenient.

In addition, since the picked-up image data is stored in the internal memory medium, the number of picked-up images is limited, and a plurality of cameras need to be carried in order to pick up a number of images, thereby resulting in a failure in the full-scale application of this system.

Furthermore, although the above-mentioned gazette discloses that picked-up image data is supplied to the user who has picked up the images on receipt of a charge, the relationship between the number of picked-up image frames and the charge is not disclosed, thereby failing to provide a rational charging system.

### SUMMARY OF THE INVENTION

The present invention is directed to an image-pickup device.

In accordance with one aspect of the present invention, this image-pickup device includes a memory medium attaching unit to which a memory medium capable of storing an image can be attached, a detector which detects whether the memory medium attached to the memory medium attaching unit has specific information, and a controller which controls executions of at least one of functions of the image-pickup device in accordance with a result of detection by the detector.

Only in the case when a memory medium in which specific information that may be referred to as image-pickup right is stored is attached thereto, at least one of functions of the image-pickup device, such as image-pickup function and reproducing function, is made executable, so that it is possible to provide an image-pickup device main body at low costs and also to prevent the user from freely using the image-pickup device upon attaching a medium other than the memory medium storing specific information.

In accordance with one preferable aspect of the present invention, upon detection of a fact that the memory medium does not have the specific information by the detector, the controller inhibits an execution of the image-pickup function.

Thus, it is possible to prevent the user from freely using the image-pickup device upon attaching a medium other than the memory medium having specific information.

In accordance with another preferable aspect of the present invention, upon detection of the fact that the memory medium does not have the specific information by the detector, the controller makes the reproducing function executable.

With this arrangement, it is possible to also confirm images stored in a memory medium in which no specific information is stored, and consequently to increase the versatility of the image-pickup device.

In accordance with still another preferable aspect of the present invention, the image-pickup device further includes a display which displays an image stored in the memory medium, and when the reproducing function is executed, the display displays a thumbnail image that correspond to an image stored in the memory medium.

Thus, it becomes possible to confirm images stored in the memory medium as the results of image-pickup processes.

In accordance with yet another preferable aspect of the present invention, the controller makes it possible to further delete an image stored in the memory medium.

This arrangement makes it possible to effectively utilize the memory medium, and also to recycle the memory medium.

In accordance with yet another aspect of the present invention, the image-pickup device includes an image generator which generates a plurality of images, a processor which executes a reproduction-limiting process on the plurality of images generated by the image generator, the reproduction-limiting process being allowed to have different conditions in canceling the reproducing-limitation depending on images, and a recorder which stores an image that has been subjected to the reproduction-limiting process by the processor in a memory medium.

With this arrangement, it is possible to prevent the user from freely reproducing images as the results of image-pickup processes, and also to set a charge for reproduction on each image-pickup frame basis; thus, it becomes possible to provide a rational charging system.

In accordance with yet another preferable aspect of the present invention, the image-pickup device further includes a thumbnail image generator which generates a thumbnail image corresponding to a picked-up image, so that the processor executes no reproduction-limiting process on the thumbnail image generated by the thumbnail image generator.

Thus, it becomes possible to confirm the picked-up image, and also to specify images to be subjected to processes, such as a deleting process, an editing process and a printing process.

The present invention is also directed to an image-processing apparatus which processes an image generated by an image-pickup device having a function of executing an image-reproduction limiting process.

In accordance with the present invention, this image-processing apparatus includes a memory medium attaching unit to which a memory medium, which stores an image executed an image-reproducing limitation by the image-pickup device, can be attached, a memory in which canceling information used for canceling the image-reproducing limitation is stored, a reader which reads out identifying information stored in the memory medium, a selector which selects the canceling information corresponding to the identifying information read out by the reader from the memory, a canceller which cancels the image-reproducing limitation from the image in accordance with the canceling information selected by the selector, a processor which processes an image from which the image-reproducing limitation has been cancelled by the canceller, and a charging unit which collects a charge corresponding to a process carried out by the processor.

When a memory medium in which an image having an image-reproducing limitation is stored is attached, in accordance with canceling information corresponding to identifying information stored in the memory medium, the image-reproducing limitation is canceled upon payment of a charge and processes such as editing and printing processes can be carried out on the image.

The present invention is also directed to a server that is used for canceling process of an image-reproducing limitation applied to an image generated by an image-pickup device having a function of executing an image-reproduction limiting process.

In accordance with the present invention, this server includes a receiver which receives identifying information stored in a memory medium from a terminal to which the memory medium in which an image subjected to the image-reproducing limitation by the image-pickup device can be attached, a memory in which canceling information used for canceling the image-reproducing limitation is stored, a selector which selects the canceling information corresponding to the identifying information received by the receiver from the memory, a transmitter which, in accordance with the canceling information selected by the selector, transmits a canceling code for canceling the image-reproducing limitation of the image to the terminal, and a connecting unit that is connected to a charging system for collecting a charge for a transmission of the canceling code to the terminal so as to carry out data communication with each other.

With this arrangement, the user can purchase the canceling code used for canceling the image-reproducing limitation by using a terminal through communication lines.

The present invention is also directed to a memory medium that is detachably attached to an image-pickup device.

In accordance with the present invention, the memory medium includes an image storing area in which an image picked up by the image-pickup device is stored, an executable information storing area in which executable information for making a function of the image-pickup device executable is stored, and a connector unit which outputs the executable information to the image-pickup device.

Thus, it is possible to prevent the user from freely using the image-pickup device upon attaching a medium other than the memory medium having the executable information.

Therefore, it is an object of the present invention to provide a digital camera, at low prices, that have no limitation to image-pickup processes, and make it possible to provide a rational charging system.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a digital camera 1 in accordance with an embodiment of the present invention;

FIG. 2 is a rear view of the digital camera 1;

FIG. 3 is a bottom view of the digital camera 1;

FIG. 4 is a block diagram showing an internal construction of the digital cameral 1;

FIGS. 5 are schematic views showing a digital camera system using the digital camera 1;

FIG. 6 is a diagram showing the memory contents in a memory card 51 with key information in which encrypted image data is stored;

FIG. 7 is a flow chart showing a schematic operation with respect to a determination as to whether a memory card 35 is usable in the digital camera 1;

FIG. 8 is a flow chart showing a schematic operation in a reproduction mode of the digital camera 1;

FIG. 9 is a flow chart showing a schematic operation in an image-pickup mode of the digital camera 1;

FIG. 10 is an external appearance view showing a data processing station 53;

FIG. 11 is a view showing a managing method of decrypting key information stored in a large capacity memory in the data processing station 53;

FIG. 12 is a schematic view showing a system which carries out a decrypting process on encrypted image data in the terminal 54 connected to a network;

FIG. 13 is a view showing a managing method of camera numbers and the acquiring state of decrypting codes that are stored in a charging server 123; and

FIG. 14 is a view showing the screen of a terminal 54 which displays images picked-up by the digital camera 1.

### DESCRIPTION OF THE PREFERRED EMBODIMENT

In the following, an embodiment of the present invention will be described with reference to the drawings.

<Configuration of Main Part of Digital Camera>

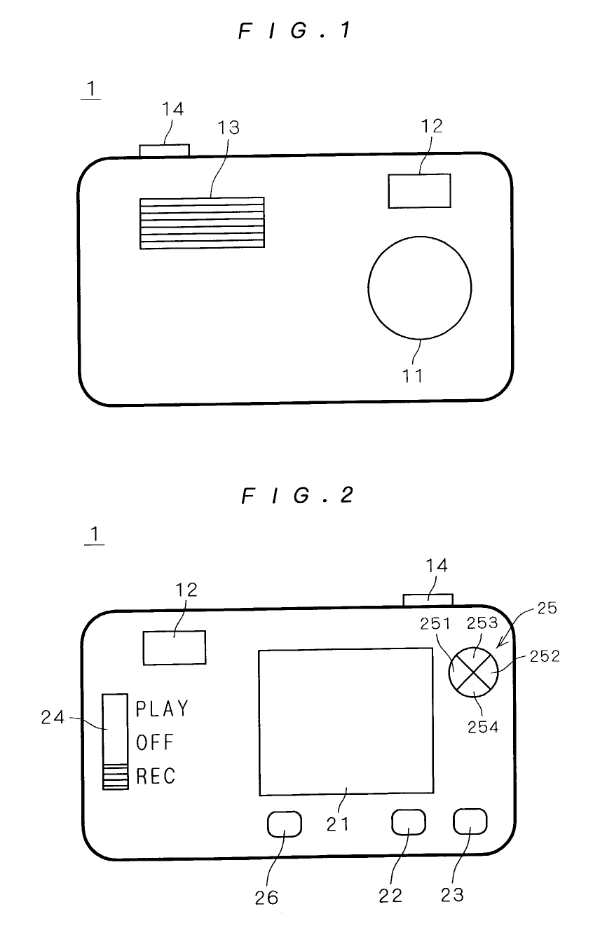

FIGS. 1 to 3 are a front view, rear view and bottom view of an image-pickup device such as a digital camera 1 in accordance with the embodiment of the present invention, respectively.

As shown in FIG. 1, the digital camera 1 includes a zoom lens 11 which is an image-pickup lens placed on a front face thereof, an optical finder 12 and a built-in flash 13 on an upper portion thereof, and a shutter button 14 which is placed on an upper face thereof, in the same manner as a silver halide lens shutter camera.

On the other hand, as shown in FIG. 2, on a rear face of the digital camera 1, a liquid crystal display LCD 21 which monitor-displays a picked-up image and reproduces and displays stored images is provided substantially in a center portion thereof. In addition, a menu key 22 used for displaying a menu image on the LCD 21 and an execution key 23 which executes items displayed on the menu image are provided at a lower right portion of the LCD 21.

Furthermore, a mode switch 24, which switches modes and also turns the power off among “image-pickup mode”, “reproduction mode” and “power-off mode”, is provided on the rear face of the digital camera 1. The image-pickup mode makes an image-pickup function for picking up images of a subject executable, and the reproduction mode makes a reproducing function for reproducing and displaying at least one picked-up image stored in a memory card on the LCD 21 executable, and the power-off mode stops a power supply to the digital camera 1 to turn the power supply off.

The mode switch 24 is a slide switch with three-contacts that functions as a setting unit for the respective modes and power-off mode, and when this is set to a bottom position in FIG. 2, the image-pickup mode is set, when set to a top position, the reproduction mode is set, and when set to a center position, the power-off mode is set.

Moreover, a quadruple switch 25 is provided on the right side of the rear face of the digital camera 1, and in the image-pickup mode, zooming processes are carried out by pressing buttons 251 and 252, while exposure correction processes are carried out by pressing buttons 253 and 254.

As shown in FIG. 2, an LCD button 26 for turning on/off the LCD 21 is provided on the rear face of the digital camera 1. When the LCD button 26 is pressed, the on/off switching of the LCD display is carried out. For example, in the case when the optical finder 12 is exclusively used to pick up images, the LCD display is turned off for the purpose of power saving.

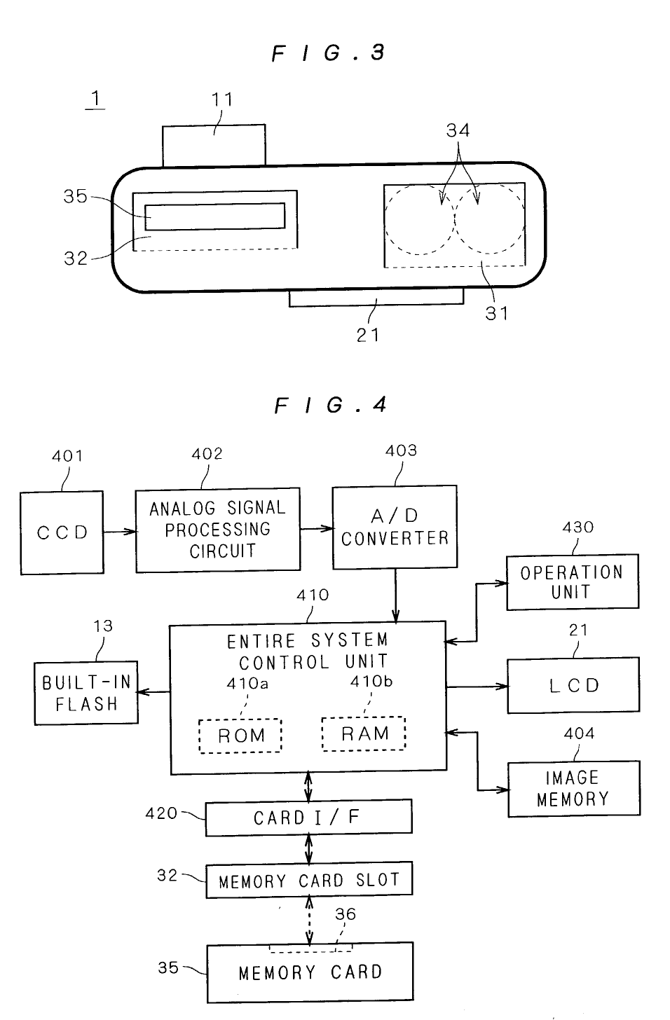

As shown in FIG. 3, a battery attaching chamber 31 and one memory card slot 32 are provided on the bottom face of the digital camera 1. A memory medium such as a memory card 35 is freely detachably attached to the memory card slot 32. In other words, the memory card slot 32 corresponds to a memory medium attaching unit to which a memory medium capable of storing at least one image can be attached.

In the digital camera 1, two batteries 34 are attached to the battery attaching chamber 31 to be used as a driving source. It is of course possible to supply power to a DC input terminal (not shown) from an adopter.

<Functional Block of Digital Camera>

FIG. 4 is a block diagram showing an internal construction of the digital camera 1. In FIG. 4, a CCD 401 photo-electrically converts an optical image of a subject formed on the CCD 401 by the zoom lens 11 serving as an image-pickup lens to image signals (signals consisting of signal columns of pixel signals received by the respective pixels) having color components of R (red), G (green) and B (blue), and outputs the resulting signals.

Noted that since the digital camera 1 has a fixed diaphragm, the exposure control at the time of an image-pickup process is carried out by adjusting the quantity of exposure of the CCD 401 (charge accumulation time of the CCD 401 corresponding to the shutter speed). In the case when it is not possible to set an appropriate shutter speed when the luminance of a subject is low, an improper exposing state due to insufficient exposure is corrected by carrying out the level adjustment of the image signal outputted from the CCD 401. In other words, the exposure control is carried out by combining the shutter speed and the gain adjustment at the time of a low luminance. Noted that the level adjustment of the image signal is carried out by an AGC (Auto Gain Control) circuit in an analog signal processing circuit 402 which will be described later.

The analog signal processing circuit 402 carries out a predetermined analog signal process on the image signal (analog signal) outputted from the CCD 401. Although not shown in the figures, the analog signal processing circuit 402 is provided with a CDS (Correlated Double Sampling) circuit and an AGC circuit installed therein, and the level of an image signal is adjusted by adjusting the gain of the AGC circuit.

The built-in flash 13 emits light in accordance with a predetermined quantity of light emission that is set by an entire system control unit 410 at the time of a flash photography.

Moreover, although not shown in the figures, a zoom motor, which changes the zoom ratio for the zoom lens 11 and shifts the lens between the housing position and the image-pickup position, is installed inside the digital camera 1.

The entire system control unit 410, which is primarily comprised of a CPU, systematically controls the image-pickup operation of the digital camera 1 by controlling the driving processes of the each peripheral component inside the digital camera 1.

Noted that, with respect to flows of image data in FIG. 4, these are indicated by arrows among each component for convenience of description; however, in fact, image data is transmitted to each of the peripheral components through the entire system control unit 410. Moreover, the entire system control unit 410 is provided with a ROM 410a such as a flash ROM for storing programs and a RAM (built-in memory) 410b such as a DRAM serving as a work RAM that are installed therein.

The ROM 410a stores detection key information which makes the image pickup mode usable in response to detection of the key information inherent to the digital camera 1 stored in a memory card 35 which will be described later, and in the case when the memory card 35 whose key information has not been stored is inserted to the memory card slot 32 in the digital camera 1, the entire system control unit 410 inhibits the use of the image-pickup mode on the basis of the detection key information. Noted that the key information is stored in the memory card 35 so as to inhibit the user from freely reading the key information. Moreover, the ROM 410a also stores the camera number that functions as the identifying number of the digital camera 1, an encrypting program and encrypting key information which is an encrypting algorithm used for encrypting image data, which will be described later. Noted that the key information, the detection key information, the camera number, the encrypting key information and the encrypting program are preliminarily set by the administrator of a recycling system of the digital camera.

An A/D converter 403 converts a pixel signal of an image signal into a digital signal of 12 bits. The A/D converter 403 converts each pixel signal (analog signal) to a digital signal of 12 bits on the basis of a clock for A/D conversion which is inputted from a timing generation circuit. Noted that although not shown in the figures, a timing control circuit, which generates the clock to the A/D converter 403, is provided, and the timing control circuit is controlled by a reference clock generated by the entire system control unit 410.

Moreover, although not shown in the figures, the entire system control unit 410 is provided with a black-level correction circuit for correcting the black level of an A/D converted pixel signal to a reference black level, a WB (White Balance) circuit which converts the level of pixel data of each of the color components of R, G and B by using a level conversion table inputted from the entire system control unit 410, and a γ correction circuit for correcting the gradation of pixel data. A digital signal outputted from the A/D converter 403 is subjected to these processes in the entire system control unit 410, in the order of the black level correction circuit, the WB circuit and the γ correction circuit.

An image memory 404 is stores pixel data outputted from the γ correction circuit inside the entire system control unit 410. The image memory 404 has at least a memory capacity of image data corresponding to 1600×1200 pixels that are equivalent to the number of pixels in the CCD 401, and the pixel data is stored in each pixel position.

Moreover, in an image-pickup stand-by state in the image-pickup mode, respective pixel data of images that have been picked up with predetermined intervals is subjected to a predetermined signal processes through the A/D converter 403 to the γ correction circuit inside the entire system control unit 410, and then temporarily stored in the image memory 404, and also displayed as an image on the LCD 21 through the entire system control unit 410. This allows the user to visually confirm the subject image.

Moreover, in the reproduction mode, an image read from the memory card 35 is subjected to a predetermined signal process in the entire system control unit 410, and then reproduced and displayed on the LCD 21.

A card I/F 420 is an interface used for writing and reading image data to and from the memory card 35, which is a memory medium, through the memory card slot 32. Moreover, it is possible to incorporate a control program stored in the memory medium such as the memory card 35 into the ROM 410a of the entire system control unit 410 through the card I/F 420.

An operation unit 430 is formed of various buttons and levers, such as the shutter button 14, the menu key 22, the execution key 23, the mode switch 24, the quadruple switch 25 and the LCD button 26.

Moreover, when each of the buttons 251 and 252 is pressed, a signal from the corresponding button is sent to the entire system control unit 410, so that, on the basis of instructions from the entire control unit 410, a zoom motor (not shown) is driven to shift the zoom lens 11 so as to carry out a zooming process.

As described above, the each construction inside the digital camera 1 has been described; however, the entire system control unit 410 carries out various functions in addition to data transmitting and receiving controls to and from peripheral components and timing controls thereof through software.

For example, the entire system control unit 410 has a luminance determining function and a shutter-speed setting function of setting an exposure control value (shutter speed). The luminance determining function is used for determining the brightness of a subject by utilizing images that are acquired by the CCD 401 every 1/30 seconds and stored in the image memory 404 in an image-pickup stand-by state. The shutter-speed setting function is used for setting the shutter speed (integrated time of the CCD 401) on the basis of the result of determination on the brightness of the subject obtained by the luminance determination.

Moreover, the entire system control unit 410 is further provided with a filtering process function, a stored image generating function, an image encrypting function and a reproduced image generating function so as to carry out storing processes of picked-up images.

The filtering process function is used for correcting the high frequency component of an image (image data) to be stored through a digital filter so as to carry out the image-quality correction with respect to the outline.

The stored image generating function is used for reading pixel data from the image memory 404 and generating a thumbnail image and a compressed image to be stored in the memory card. More specifically, a scanning process is carried out on the image memory 404 in raster scanning directions so that pixel data is read out every 8 pixels in the respective lateral direction and longitudinal direction, and the resulting pixel data is successively transferred to a memory card, so that the compressed image and the thumbnail image are stored in the memory card 35 while the thumbnail image is being generated. Moreover, all the pixel data are read from the image memory 404, so that these pixel data are subjected to a two-dimensional DCT conversion and a predetermined compressing process by a JPEG system such as Huffman coding process.

The image encrypting function is used for carrying out an encrypting process using a system such as a scramble system on image data that have been subjected to a predetermined compressing process of a JPEG system such as Huffman coding by the stored image generating function. The encrypting process is carried out based upon the encrypting key information stored in the ROM 410a. Here, the encrypting key information is an algorithm which determines an encrypting code by combining camera manufacturing information such as a camera number that is stored in the ROM 401a and image pickup information such as image pickup conditions. Moreover, the ROM 410a also stores an encrypting program which actually carries out an encrypting process on image-pickup data in accordance with encrypting codes, and by applying the encrypting codes to the encrypting program, the encrypting process on picked-up image data is achieved. The image-pickup conditions include a frame number of a picked-up image, an image-pickup date, etc., and the encrypting process on the image-pickup data is different depending on individual digital cameras 1, and a different encrypting process is carried out on each piece of picked-up image data. Then, the encrypted image data encrypted by the image encrypting function is stored in the memory card 35. In this case, after a predetermined compressing process by a JPEG system through the stored image generating function, the encrypting process is carried out by the image encrypting function; however, the present invention is not intended to be limited by this method, and the compressing process and the encrypting process may be carried out in parallel with each other.

The encrypted image data stored in the memory card 35 prevents the user from freely carrying out a reproducing process of picked-up image data, unless the corresponding decrypting process is carried out based upon the decrypting key information (canceling information) which will be described later.

With respect to specific operations, when an image-pickup operation is instructed by the shutter button 14 in the image-pickup mode, a piece of thumbnail image data corresponding to an image stored in the image memory 404 after the image-pickup instruction and a piece of encrypted image data obtained by encrypting a compressed image compressed by a JPEG system in accordance with a set compressing rate are generated, and the two pieces of image data are stored in the memory card 35 together with tag information relating to the picked-up image that consists of camera manufacturing information and image-pickup conditions (information such as camera number, frame number, exposing value, shutter speed, compressing rate, image-pickup date, data relating to on/off of flash at the time of the image pickup, scene information and the results of determination of the image).

Moreover, the reproduced image generating function is a function of displaying thumbnail images corresponding to picked-up image data stored in the memory card 35, on the LCD 21. With respect to specific operations, when the mode switch 24 is set to a reproduction mode, a thumbnail image having the greatest frame number in the memory card 35, that is, image-picked up immediately before, is reproduced and displayed.

<Outline of Digital Camera System>

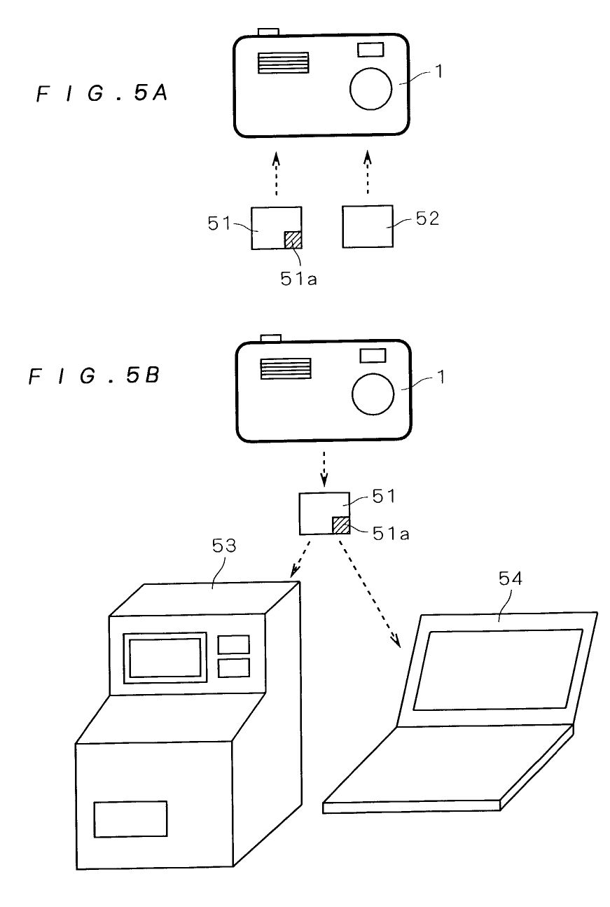

FIGS. 5 are schematic views showing a digital camera system using the digital camera 1 in accordance with an embodiment of the present invention.

As shown in FIG. 5A, when a memory card (a memory card 51 with key information) having a portion 51a storing the specific key information (executable information) is inserted to the memory card slot 32, the digital camera 1 makes both of the image-pickup mode and the reproduction mode operable. On the other hand, when a memory card (a memory card 52 without key information) having no portion 51a storing the specific key information is inserted to the memory card slot 32, it makes the image-pickup mode inoperable, while making the reproduction mode operable. In this case, since the image-pickup mode is made operable in response to detection of the specific key information, the entire system control unit 410 determines whether the image-pickup mode is made operable on the basis of the detection key information stored in the ROM 410a.

Noted that the specific key information is taken in the entire system control unit 410 from a connector unit 36 provided in the memory card 35 through the memory card slot 32 and the card I/F 420 of the digital camera 1.

Next, as shown in FIG. 5B, when, upon completion of desired image-pickup processes, the memory card 51 with key information storing encrypted image data is taken out of the digital camera 1, and brought to a data processing station 53 (an image-processing apparatus), the decrypting process for returning the encrypted image data to the original image-pickup image data is carried out by paying a charge, so that editing and printing processes of at least one picked-up image is made operable. Moreover, the memory card 51 with key information storing encrypted image data is brought to a terminal 54 connected to a network, so that a decrypting code is obtained by paying a charge through the communication line or a decrypting program is also obtained through the communication line. In this case, it is possible to carry out a decrypting process (that is, canceling a reproducing limitation) for returning the encrypted image data to the original picked-up image data by using the decrypting code and the decrypting program. A detailed description of the decrypting process and a detailed description of a digital camera system in accordance with the embodiment of the present invention, such as the data processing station 53 and the terminal 54 connected to the network, will be given later.

<Memory Contents stored in Memory Card with Key Information>

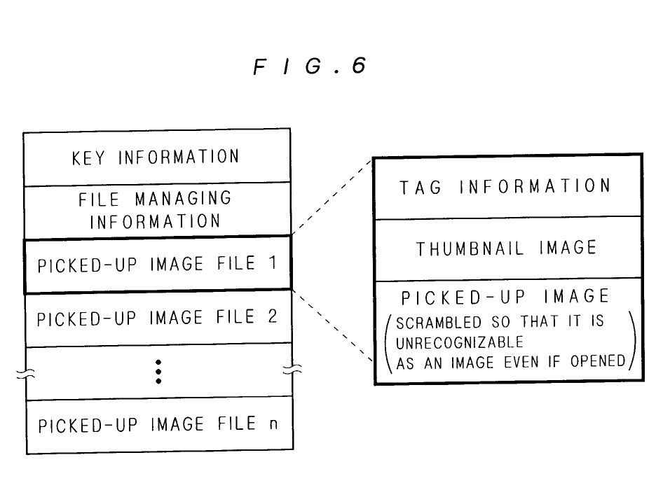

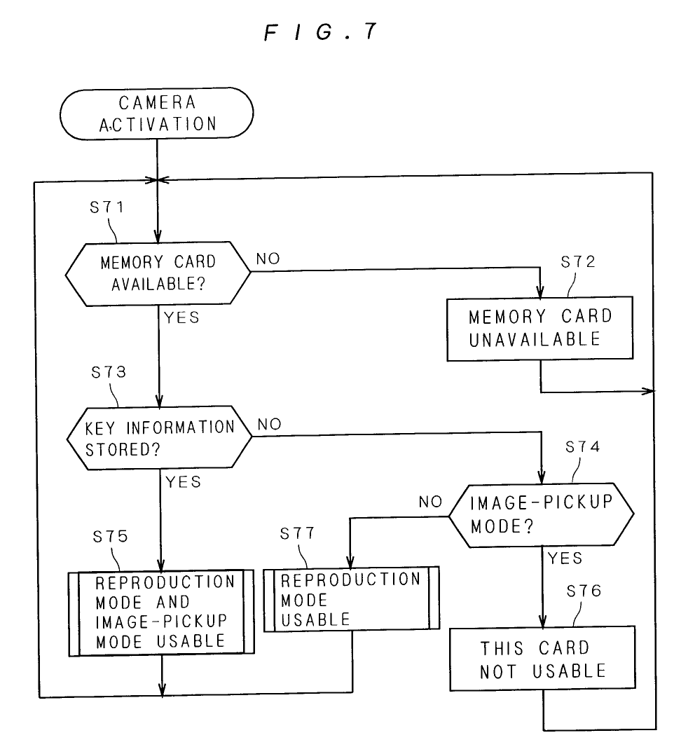

FIG. 6 is a diagram showing the memory contents inside the memory card 51 with key information storing encrypted image data.

The memory contents stored in the memory card 51 with key information include the key information, file managing information and a group of image files (picked-up image files) of picked-up images.

As described above, upon inserting the memory card 51 with key information having the key information to the memory card slot 32, the key information makes the image-pickup mode usable on the basis of the detection key information stored in the ROM 410a.

Each of the groups of picked-up image files is formed of one or more picked-up image files, and each of the picked-up image files is formed of tag information, a thumbnail image and a picked-up image. Here, as described above, the tag information includes descriptions of camera manufacturing information and image-pickup conditions, and the picked-up image is encrypted image data that has been scrambled. Therefore, even when the picked-up image is opened by using a personal computer, etc., this is not recognized as an image because of the scrambled state, thereby substantially giving a reproducing limitation.

<Determination as to Whether Memory Card Is Usable>

FIG. 7 is a flow chart of a schematic operation for determining whether the memory card 35 is usable, which are carried out in the digital camera 1. As described above, the determination as to whether the memory card 35 is usable is made by the entire system control unit 410 on the basis of the detection key information stored in the ROM 410a, which corresponds to the key information.

In this case, when the mode switch 24 is slid vertically to be set to the image-pickup mode or the reproduction mode, the sequence proceeds to step S71.

At step S71, a determination is made as to whether the memory card 35 has been inserted into the memory card slot 32. If the memory card slot 32 has no memory card 35, the sequence proceeds to step S72, and if the memory card slot 32 has the memory card 35, the sequence proceeds to step S73.

At step S72, a warning, “no memory card”, indicating that no memory card 35 has been inserted to the memory card slot 32 is displayed on the LCD 21, and the sequence returns to step S71. Noted that, in a state where no memory card 35 has been inserted to the memory card slot 32, the processes of steps S71 and S72 are repeated, and when the memory card 35 has been inserted to the memory card slot 32, the sequence proceeds to step S73.

At step S73, detection and determination are made as to whether the memory card 35 that has been inserted to the memory card slot 32 has the portion 51a storing the specific key information. If there is no portion 51a storing the specific key information, the sequence proceeds to step S74, while if there is the portion 51a storing the specific key information, the sequence proceeds to step S75. Noted that, as described above, a memory card having the portion 51a storing the specific key information is referred to as the memory card 51 with key information, and a memory card having no portion 51a storing the specific key information is referred to as the memory card 52 without key information.

At step S74, a determination is made as to whether the current mode is the image-pickup mode or the reproduction mode. Here, if the current mode is the image-pickup mode, the sequence proceeds to step S76, and if the current mode is the reproduction mode, the sequence proceeds to step S77.

At step S75, since the memory card 51 with key information has been inserted to the memory card slot 32, either of the image-pickup mode and the reproduction mode is usable. When the memory card 51 with key information has been detached from the memory card slot 32, the sequence returns to step S71.

At step S76, a warning, “this card is not usable”, indicating that the memory card 52 without key information is not usable in the image-pickup mode is displayed on the LCD 21, and the sequence returns to step S71.

At step S77, since the memory card 52 without key information has been inserted to the memory card slot 32, it is possible to use the digital camera 1 freely only in the case of the reproduction mode. Therefore, at least one image picked up by another digital camera can be displayed. In other words, the memory card 52 without key information is usable only in the reproduction mode. When the memory card 52 without key information has been detached from the memory card slot 32, the sequence returns to step S71.

Here, only the memory card 51 with key information having the portion 51a storing the specific key information is made usable in both of the image-pickup mode and the reproduction mode; therefore, in order to pick up at least one image by using the digital camera 1, it is necessary to purchase the memory card 51 with key information.

Here, the key information of the memory card 51 with key information is used for providing a kind of image-pickup right, and the memory card 51 with key information is set to a price higher than the price of the memory card 52 without key information by the image-pickup right, in return for the low price of the digital camera 1. Moreover, when the memory capacity increases, the number of pickup images also increases correspondingly, so that the image-pickup right increases. In other words, the price is set depending not only on the amounts of the capacity, but on the amount of the image-pickup right of the corresponding card.

Here, the memory card 51 with key information has the same construction as the memory card 52 without key information, except for the key information, and is applicable to other general digital cameras and personal computers, in addition to the digital camera 1. This is made by adding key information to a general-use memory card on a software basis, and this makes it possible to reduce the cost of the memory card 51 with key information.

Moreover, by providing an arrangement in which even the memory card 52 (general use memory card) without key information having no portion 51a storing the specific key information is made usable in the reproduction mode, it is possible to provide a digital camera that is superior in versatility.

<Operations in Reproduction Mode>

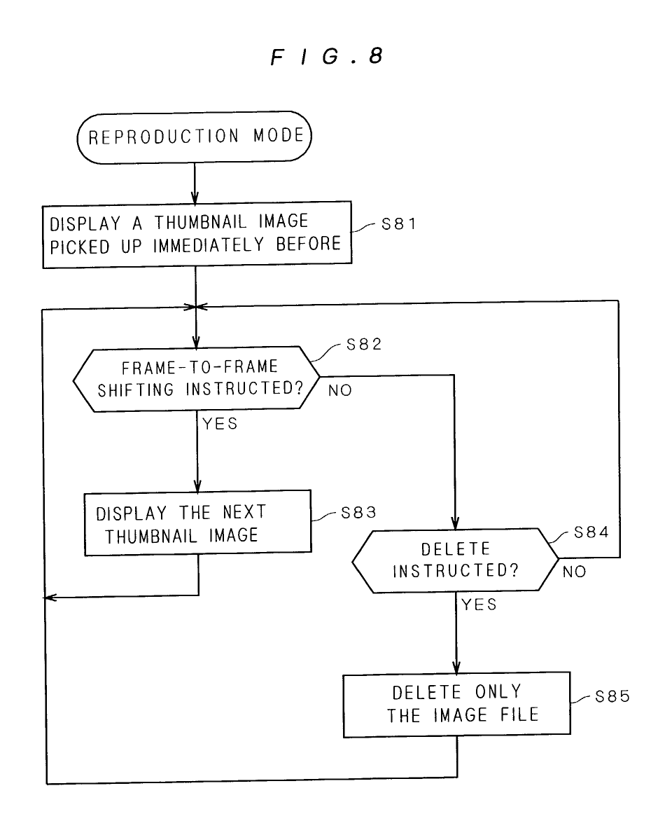

FIG. 8 is a flow chart showing a schematic operation in the reproduction mode in the digital camera 1. In this case, the operation in the reproduction mode is controlled by the entire system control unit 410.

The reproduction mode becomes usable even when any one of the memory card 51 with key information and the memory card 52 without key information is inserted to the memory card slot 32, and in any of the cases where the memory card 51 with key information is used and the memory card 52 without key information is used, there is no difference in the operations in the reproduction mode; therefore, on the assumption that the memory card 51 with key information is inserted to the memory card slot 32, the schematic operation in the reproduction mode will be described.

In this case, the memory card 51 with key information is inserted to the memory card slot 32, and when the mode switch 24 is slid to be set to the reproduction mode, the sequence proceeds to step S81.

At step S81, first, a thumbnail image of an image picked up immediately before is displayed on the LCD 21, and the sequence proceeds to step S82.

At step S82, a determination is made as to whether a frame-to-frame shifting process, which displays a thumbnail image other than the currently displayed thumbnail images on the LCD 21 among the images stored in the memory card 51 with key information, has been instructed. Here, when the frame-to-frame shifting process has been instructed, the sequence proceeds to step S83, while when no frame-to-frame shifting process has been instructed, the sequence proceeds to step S84. Noted that the instruction for the frame-to-frame shifting process is given when the user operates the quadruple switch 25 laterally.

At step S83, in accordance with the frame-to-frame shifting instruction by the user, the thumbnail image of the next image is displayed on the LCD 21, and the sequence returns to step S82. Noted that image-pickup conditions may be read out and displayed by operations of the menu key 22 and the execution key 23.

At step S84, a determination is made as to whether a deleting instruction for any image stored in the memory card 51 with key information has been given. Here, although not shown in figures, there are two types of deletion processes, that is, a deletion process for only the image (displayed image) whose thumbnail image is being currently displayed on the LCD 21 and a deletion process for all the images (all images) stored in the memory card 51 with key information. In this case, although not shown in figures also with respect to the deleting instruction for at least one image, the instruction is given by allowing the user to operate the quadruple switch 25 and the execution key 23. Then, in any of the cases where the deletion of only the displayed image is instructed and where the deletion of all the images is instructed, the sequence proceeds to step S85, and in the case of no instruction for deletion of images, the sequence returns to step S82.

At step S85, only the corresponding image file is deleted on the basis of the deleting instruction at step S84. In other words, in the case of the instruction for deleting only the displayed image, only the displayed image is deleted from the memory card 51 with key information. Moreover, in the case of the instruction for deleting all the images, all the images stored in the memory card 51 with key information are deleted from the memory card 51 with key information. Here, even when the instruction for deleting all the images is given, key information, which is stored in the memory card 51 with key information, is not deleted from the memory card 51 with key information. Normally, since a formatting process of a memory card carried out in a digital camera is not selected from a menu, it is possible to prevent the key information from being deleted by an erroneous formatting process.

In this manner, in the reproduction mode, any desired image file stored in the memory card 51 with key information can be deleted; however, the key information is not deleted. Therefore, the memory card 51 with key information can be used repeatedly as many times as desired by deleting image files while confirming a thumbnail image of the picked-up image.

<Operations in Image-Pickup Mode>

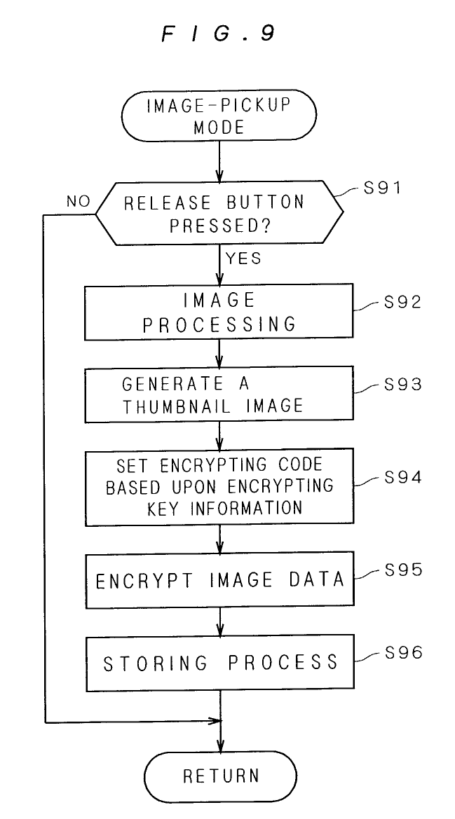

FIG. 9 is a flow chart showing a schematic operation in the image-pickup mode in the digital camera 1. In this case, the operation in the image-pickup mode is controlled by the entire system control unit 410.

In this case, when, after the memory card 51 with key information has been inserted to the memory card slot 32, the mode switch 24 is slid downward to be set to the image-pickup mode, the sequence proceeds to step S91.

At step S91, a determination is made as to whether the shutter button 14 (release button) for picking up an image of a subject has been pressed down. In this case, when the shutter button 14 is pressed down, the sequence proceeds to step S92, and when the shutter button 14 is not pressed down, the sequence returns to step S91. In other words, in an image-pickup stand-by state in the image-pickup mode, the determining process at step S91 is repeated until the shutter button 14 has been pressed down.

At step S92, an image signal outputted from the CCD 401 is inputted to the entire system control unit 410 through the analog signal processing circuit 402 and the A/D converter 403 in succession, is subjected to processes in the black-level correction circuit, the WB circuit and the γ correction circuit in succession in the entire system control unit 410, and is temporarily stored in the image memory 404 as pixel data. Then, the high frequency portion of the image is corrected by the filtering process function in the entire system control unit 410, so that the image quality is corrected with respect to the outline portion, and a compressed image is generated by the storing image generation function. In this manner, at step S92, a compressed image is generated, and the sequence proceeds to step S93.

At step S93, pixel data is read from the image memory 404 and a thumbnail image is generated by the stored image generating function in the entire control unit 410, and the sequence proceeds to step S94.

At step S94, in accordance with the encrypting key information stored in the ROM 410a in the entire system control unit 410, an encrypting code is set. That encrypting code is determined by combining the camera number, the image-pickup conditions, etc. on each frame basis on the basis of a specific rule. Here, the encrypting code is different depending on digital cameras and also depending on picked-up images. In this manner, at step S94, the encrypting code is set, and the sequence proceeds to step S95.

At step S95, the encrypting code, set by the image encrypting function at step S94 in the entire system control unit 410, is applied to the encrypting program stored in the ROM 410a, so that the compressed image data is subjected to an encrypting process. In this manner, at step S95, the picked-up image data is encrypted, and the sequence proceeds to step S96.

At step S96, the thumbnail image generated at step S93, the encrypted image data encrypted at step S95 and tag information relating to the picked-up image consisting of camera manufacturing information and image-pickup conditions (information such as camera number, frame number, exposing value, shutter speed, compressing rate, image-pickup date, data relating to on/off of flash at the time of the image pickup, scene information and the results of determination of the image) are recorded in the memory card 51 with key information. In this manner, at step S96, the storing processes of the thumbnail image, encrypted image data and tag information relating to the picked-up image are carried out, and the sequence then returns to step S91, thereby entering the stand-by state for an image-pickup process again.

Here, on the basis of the encrypting key information and camera manufacturing information stored in the ROM 410a, and on the basis of the image-pickup conditions, an encrypting code that is different depending on digital cameras and also depending on picked-up images is set, and by applying the encrypting code to the encrypting program stored in the ROM 410a, it is possible to carry out an encrypting process that is different depending on digital cameras and also depending on picked-up images. Here, since the thumbnail image and the image-pickup conditions are stored in the memory card 51 with key information without being encrypted, the user is allowed to confirm the contents of the image-pickup process.

<Decrypting Process in Data Processing Station>

FIG. 10 is an external appearance view showing the data processing station 53 in accordance with the embodiment of the present invention.

In this data processing station 53, by bringing the memory card 51 with key information storing encrypted image data thereto, the encrypted image data is decrypted upon payment of a charge, and image processing that includes editing and printing processes are carried out thereon. Here, the editing process of the image data includes, for example, the size conversion and tone conversion of the image data.

The data processing station 53 is mainly classified into a device main body 110 housed inside a housing HG having a substantially box shape and an operation input unit 111 placed on the front face (on the operator side) of this housing HG.

The operation input unit 111 is provided with a digital I/F unit 112, a display unit 113 and a vending unit 114.

The digital I/F unit 112 is provided for the purpose that the user brings the memory card 51 with key information which is detachably attached to a digital camera, etc. so as to read digital information from the memory card 51 with key information, etc., and is provided with an attaching unit to which the memory card 51 with key information storing the picked-up images, etc. is detachably attached. The display unit 113 has a CRT which allows the user to confirm the picked-up images stored in the memory card 51 with key information through thumbnail images. Moreover, although not shown in the figures, a transparent touch panel is placed on the display surface of the display unit 113, so that, by touching the surface of the screen in accordance with the guidance on the screen, the user is allowed to carry out operations in such a manner as to communicate with the data processing station 53. The vending unit 114 is a unit for collecting charges, and a predetermined charge is inserted therein by a bill or coins as a consideration for the service (processes such as a decrypting process of the encrypted image data, editing process of the picked-up image data and printing process of the picked-up image, etc.).

Moreover, the device main body 110 has a print outlet 115, a control circuit (not shown) for the data processing station 53 and a non-volatile large capacity memory such as a hard disk.

The print outlet 115 is an outlet from which photographs, etc. that have been printed on the basis of picked-up image data in the printing unit (not shown) are taken out.

The control circuit controls and manages all the operations of the data processing station 53 by using programs, etc. stored in the large capacity memory. The decrypting process of the encrypted image data, the editing process of the picked-up image data and printing process of the picked-up image data are achieved by the control circuit.

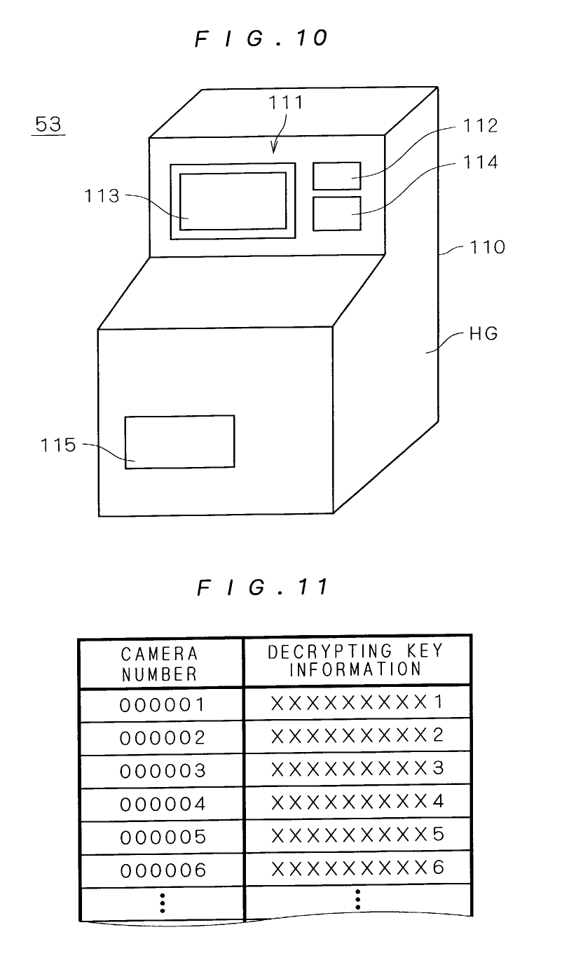

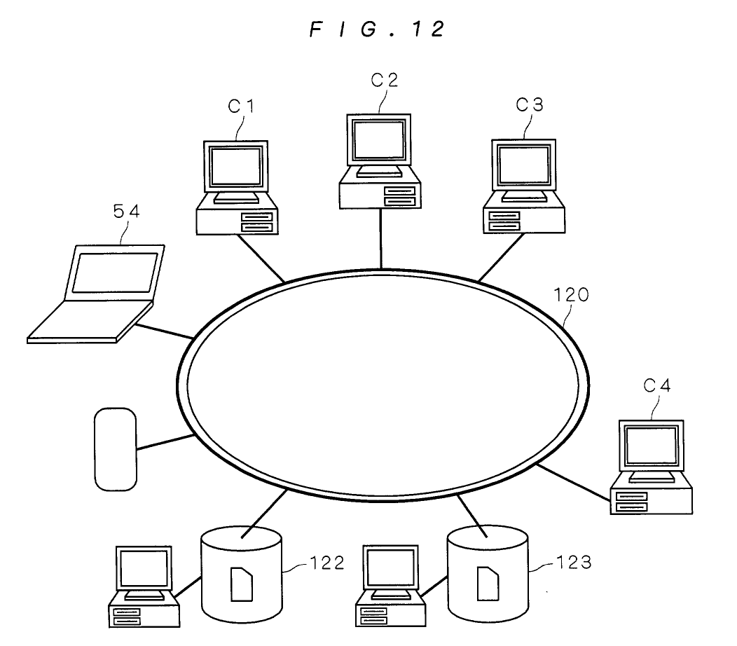

FIG. 11 shows a managing method of the decrypting key information used for decrypting encrypted image data in the large capacity memory. As shown in FIG. 11, pieces of decrypting key information respectively corresponding to a plurality of camera numbers are stored in the form of two-dimensional tables. Moreover, the large capacity memory also stores a decrypting program that decrypts the encrypted image data to the original picked-up image data.

Accordingly, description of a schematic operation for decrypting the encrypted image data and for printing in accordance with the resulting data in the data processing station 53 is as follows. When the user specifies a desired image (picked-up image to be printed) among the encrypted images that is to be decrypted and printed by touching the transparent touch panel on the display surface of the display unit 113, the camera number stored in the tag information of the memory card 51 with key information is read and referred to, so that the decrypting key information corresponding to the camera number is selected and read out from the large capacity memory. In addition, the image-pickup conditions, etc. stored in the respective image file corresponding to the picked-up image to be printed are referred to, and on the basis of the decrypting key information, decrypting codes with respect to the individual picked-up images to be printed are outputted. Then, by applying the decrypting codes to the decrypting program, the decrypting process (canceling an image-reproducing limitation) is carried out on the encrypted image data, and the decrypted picked-up image is printed.

<Decrypting Process in Terminal Connected to Network>

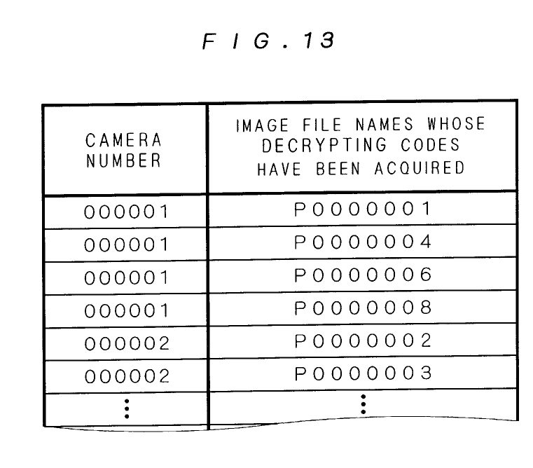

FIG. 12 is a schematic view showing a system for decrypting encrypted image data in the terminal 54 connected to a network.

As shown in FIG. 12, the network is formed of the terminal 54, a server 122, a charging server (charging system) 123 and a plurality of terminals C1 to C4 that are connected through communication lines 120.

Here, the memory card 51 with key information storing encrypted image data is brought to the terminal 54, so that the server 122 supplies the decrypting code through the communication lines 120 on receipt of the charge, and the decrypting process on the encrypted image data is carried out by using the decrypting code and the decrypting program. The charge for obtaining the decrypting code is managed by the charging server 123, and the decrypting program is obtainable from the server 122 through the communication lines 120. With respect to the decrypting code and the decrypting program, the same decrypting code and decrypting program as those used in the above-mentioned data processing station are applied. Here, the algorithm of the decrypting key information used for calculating the decrypting code is kept a secret from the user so that the user is not allowed to freely carry out the decrypting process on the image data. The server 122, the charging server 123 and the terminal 54 will be described in detail later.

The server 122, which is of a managing company of the system of the digital camera 1, has a large capacity memory unit (not shown) that stores at least one camera number and a corresponding piece of decrypting key information in the form of two-dimensional tables shown in FIG. 11, in the same manner as the large capacity memory of the data processing station 53. Moreover, the server 122 is provided with a control unit (not shown), and this control unit controls and manages all the operations in the server 122 by using programs, etc. stored in the large capacity memory unit. Therefore, the control unit receives the camera number written in the tag area of the picked-up image file forming of the encrypted image data stored in the memory card 51 with key information from the terminal 54 through the communication lines 120, and selects and reads out the decrypting key information corresponding to the camera number from the large capacity memory in the same manner as the above-mentioned data processing station 53. Then, on the basis of the decoding key information thus read out, it outputs the decrypting code with respect to individual image data to be decrypted using the received camera number and the image-pickup conditions. Moreover, the server 122 stores a decrypting program that actually decrypted the encrypted image data by applying the decrypting code thereto, and delivers the decrypted code and the decrypting program to the terminal 54 by the communication unit through the communication lines 120. Moreover, instead of obtaining it through the communication lines 120, the decrypting program may be obtained as a memory medium storing the program such as a floppy disk™ at a shop, etc.

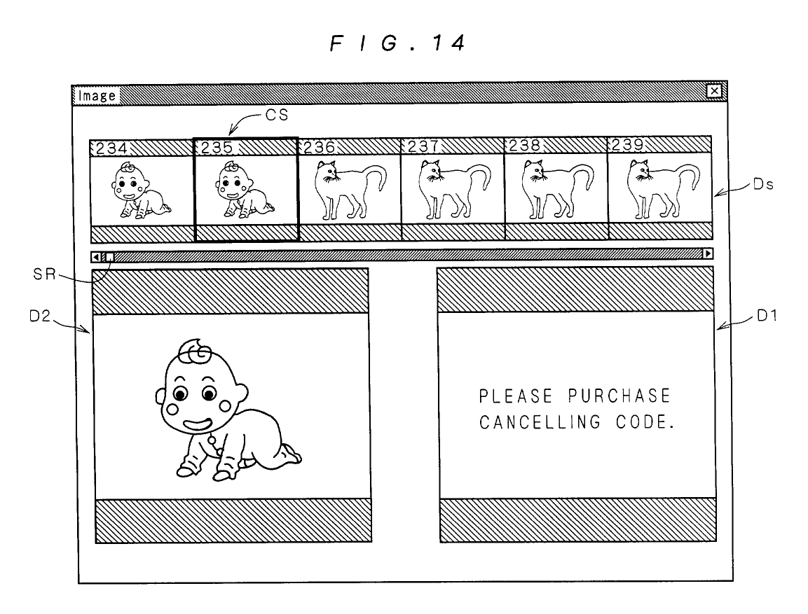

The charging server 123, which is a charging system of a card company, etc., is a server that manages charges with respect to decrypting codes that the user obtained through communication from the server 122, and as shown in FIG. 13, stores camera numbers and the acquiring state of the corresponding decrypting codes (image file names whose decrypting codes have been acquired) in the form of two-dimensional tables. In this case, with respect to each camera number, the image file names whose decrypting codes have been acquired are stored so that the number of image files whose decrypting codes have been acquired by the respective users is confirmed. As a result, the respective charges are determined and the charges are collected from the corresponding bank accounts of the users.

When the memory card 51 with key information storing encrypted image data is attached to its card I/F (not shown), the terminal 54 is allowed to reproduce the picked-up image data stored in the memory card 51 with key information through the decrypting code and the decrypting program. As described above, the terminal 54 is allowed to acquire the decrypting code and the decrypting program from the server 122 through the communication lines 120.

FIG. 14 shows a display screen of the terminal 54 which displays images picked up by the digital camera 1. Here, it is assumed that the user has already acquired the decrypting program, and has installed it in the terminal 54. First, a thumbnail image group Ds of picked-up images stored in the memory card 51 with key information is displayed on the upper portion of the screen. More specifically, six frames of thumbnail images 234 to 239 are displayed in a laterally aligned form from right to left. Then, a thick line cursor CS is shifted by a cross-shaped key (not shown), so that a frame of desired picked-up image to be displayed are selected from the group of thumbnail images Ds. If the selected frame is a frame whose decrypting code has been acquired from the server 122, the corresponding picked-up image is displayed, for example, as an image D2 on the left side of the screen when an enter key (not shown) is pressed down. Here, in the case when the selected frame is a frame whose decrypting code has not been acquired from the server 122, upon pressing the enter key, not shown, a message, “Please purchase the canceling code”, is displayed as a warning display D1 on the right side of the screen. In other words, the picked-up images whose decrypting codes have been acquired can be displayed as images, while the picked-up images whose decrypting codes have not been acquired are not displayed as images freely by the user, with the result that the user is not allowed to freely carry out editing and printing processes on the picked-up image.

Noted that, as shown in FIG. 14, only the frames of six thumbnail images 234 to 239 are displayed on the screen; however, in the case when a number of pieces of picked-up image data are further stored in the memory card 51 with key information, frames of other images may be selectively displayed on the screen by using a lateral scrolling process of the scroll bar SR.

As described above, when the user picks up images by using the digital camera 1, encrypting processes that are different depending on digital cameras and also depending on picked-up images are carried out on individual picked-up images, and the resulting images are stored in the memory card 51 with key information. Therefore, in a data processing station, the user must decrypt the encrypted image data by paying the corresponding charge so as to carry out editing and printing process thereon, or acquire the decrypting code for decrypting encrypted image data by paying the corresponding charge so as to carry out editing and printing processes in the terminal 54 connected to the network. It is possible to provide a limitation to use so as to prevent the user from freely reading the picked-up image data.

<Modified Example>

In the above-mentioned embodiment, an encrypting process such as scrambling is carried out on the picked-up image data; however, the limitation to reproduction is not limited to this method, and a protect may be set to the picked-up image data, so that it is possible to prevent the user from freely reading the picked-up image data unless a specific canceling code is given.

Moreover, in the above-mentioned embodiment, an encrypting code is set on the basis of the number of the digital camera and individual image-pickup conditions; however, image-pickup serial numbers may be applied to each memory card 51 with key information, so that an encrypting rule for determining an encrypting code on the basis of the number of the memory card 51 with key information and the image-pickup serial number of the used memory card may be set so as to provide an encrypting process that is different on each picked-up image basis.

In the case when the image-pickup serial numbers are applied to each memory card 51 with key information, for the purpose of simplicity, the same encrypting code may be applied in the same manner not to each picked-up image, but to each memory card. Even in this case, it is possible to achieve the effect that the camera main body needs not be brought to a shop.

Moreover, in the above-mentioned embodiment, on the basis of the encrypting key information corresponding to the number of a digital camera, a decrypting code is outputted by reference to image-pickup conditions, etc.; however, image-pickup serial numbers may be applied to each memory card 51 with key information, and on the basis of decrypting key information corresponding to the number (identifying number) of the memory card 51 with key information and to an image-pickup serial number (number for identifying each picked-up image) representing the use of the memory card, the decrypting code may be outputted by reference to image-pickup conditions, etc.

While the invention has been described in detail, the foregoing description is in all aspects illustrative and not restrictive. It is understood that numerous other modifications and variations can be devised without departing from the scope of the invention.

What is claimed is:

1. An image-pickup device comprising:
a memory medium attaching unit to which a memory medium capable of storing an image is attached;
a detector which detects whether said memory medium attached to said memory medium attaching unit has specific information; and
a controller which controls executions of at least one of functions of the image-pickup device in accordance with a result of detection by said detector.

2. The image-pickup device according to claim 1, wherein
the functions of said image-pickup device include an image-pickup function of picking up an image of a subject and a reproducing function of reproducing an image stored in said memory medium, and
upon detection of a fact that said memory medium has said specific information by said detector, said controller makes said image-pickup function and said reproducing function executable.

3. The image-pickup device according to claim 2, wherein
upon detection of a fact that said memory medium does not have said specific information by said detector, said controller inhibits an execution of said image-pickup function.

4. The image-pickup device according to claim 3, wherein
upon detection of the fact that said memory medium does not have said specific information by said detector, said controller makes said reproducing function executable.

5. The image-pickup device according to claim 4, further comprising:
a display which displays an image stored in said memory medium, wherein
upon executing said reproducing function, said display displays a thumbnail image that corresponds to an image stored in said memory medium.

6. The image-pickup device according to claim 4, wherein
said controller makes it possible to further delete an image stored in said memory medium.

7. An image pickup device comprising:
an image generator which generates a plurality of images;
a processor which executes a reproduction-limiting process on said plurality of images generated by said image generator, said reproduction-limiting process being allowed to have different conditions in canceling the reproducing-limitation depending on images; and
a recorder which stores an image that has been subjected to said reproduction-limiting process by said processor in a memory medium.

8. The image-pickup device according to claim 7, wherein
said reproduction-limiting process includes an encrypting process of an image, and
said processor executes a different encrypting process depending on images on said plurality of images.

9. The image-pickup device according to claim 7, further comprising:
a thumbnail image generator which generates a thumbnail image corresponding to a picked-up image, wherein
said processor executes no reproduction-limiting process on the thumbnail image generated by said thumbnail image generator.

10. An image-processing apparatus which processes an image generated by an image-pickup device having a function of executing an image-reproduction limiting process, comprising:
a memory medium attaching unit to which a memory medium, which stores an image executed an image-reproducing limitation by said image-pickup device, can be attached;
a memory in which canceling information used for canceling said image-reproducing limitation is stored;
a reader which reads out identifying information stored in said memory medium;
a selector which selects said canceling information corresponding to said identifying information read out by said reader from said memory;
a canceller which cancels said image-reproducing limitation from said image in accordance with said canceling information selected by said selector;
a processor which processes an image from which said image-reproducing limitation has been cancelled by said canceller; and
a charging unit which collects a charge corresponding to a process carried out by said processor.

11. The image-processing apparatus according to claim 10, wherein
said image-reproduction limiting process includes an encrypting process, and
said canceller executes a decrypting process on an image that has been subjected to said encrypting process.

12. The image-processing apparatus according to claim 10, wherein
said identifying information includes an identifying number used for identifying an image stored in said memory medium.

13. The image-processing apparatus according to claim 10, wherein
said identifying information includes an identifying number of an image-pickup device that generates an image stored in said memory medium.

14. The image-processing apparatus according to claim 10, wherein
said identifying information includes an identifying number of said memory medium.

15. A server, which is used for canceling process of an image-reproducing limitation applied to an image generated by an image-pickup device having a function of executing an image-reproduction limiting process, comprising:
a receiver which receives identifying information stored in a memory medium from a terminal to which said memory medium in which an image subjected to said image-reproducing limitation by said image-pickup device can be attached;
a memory in which canceling information used for canceling said image-reproducing limitation is stored;
a selector which selects said canceling information corresponding to said identifying information received by said receiver from said memory;
a transmitter which, in accordance with said canceling information selected by said selector, transmits a canceling code for canceling said image-reproducing limitation of said image to said terminal; and
a connecting unit which is connected to a charging system for collecting a charge for a transmission of said canceling code to said terminal so as to communicate with each other.

16. The server according to claim 15, wherein
said image-reproduction limiting process includes an encrypting process, and
said canceling process of the image-reproducing limitation includes a decrypting process to said image that has been subjected to said encrypting process.

17. The server according to claim 15, wherein
said identifying information includes an identifying number used for identifying an image stored in said memory medium.

18. The server according to claim 15, wherein
said identifying information includes an identifying number of an image-pickup device that generates an image stored in said memory medium.

19. The server according to claim 15, wherein
said identifying information includes an identifying number of said memory medium.

20. A memory medium, which is detachably attached to an image-pickup device, comprising:
an image storing area in which an image picked up by said image-pickup device is stored;
an execution enabling information storing area in which executable information for making a function of said image-pickup device executable is stored; and
a connector unit which outputs said executable information to said image-pickup device.

21. The memory medium according to claim 20, wherein
said function of said image-pickup device include image-pickup function.
